(19) United States
(12) Patent Application Publication
(10) Pub. No.: US 2024/0369230 A1
(43) Pub. Date: Nov. 7, 2024

(54) DOUBLE OVEN POWER CONTROL SYSTEMS AND METHODS

(71) Applicant: Sunbeam Products, Inc., Atlanta, GA (US)

(72) Inventors: Tom Guyett, Boynton Beach, FL (US); Joseph C. Spencer, Boynton Beach, FL (US)

(21) Appl. No.: 18/553,852

(22) PCT Filed: Apr. 7, 2022
(86) PCT No.: PCT/US2022/071589

§ 371 Date: Oct. 4, 2023

Related U.S. Application Data
(60) Provisional application No. 63/171,924, filed on Apr. 7, 2021.

(51) Int. Cl. F24C 7/08; H05B 1/02

(52) U.S. Cl. CPC F24C 7/085; H05B 1/0263

(57) ABSTRACT

An oven that includes a first chamber including a first heating element and a second heating element, a second chamber including a third heating element and a fourth heating element and a plurality of electrical devices that control power supplied to the first, second, third, and fourth heating elements from a power source. A controller of the oven being configured to alter one ore more states of the plurality of electrical devices to control the power supplied to the first, second, third, and fourth heating elements according to a selected operating mode, and/or a respective current temperature of the first and second chambers.

### CROSS-REFERENCE TO RELATED APPLICATIONS

This application claims priority to U.S. Application No. 63/171,924 filed Apr. 7, 2021 and titled “DOUBLE OVEN POWER CONTROL SYSTEMS AND METHODS.” U.S. Application No. 63/171,924 is hereby fully incorporated by reference as if set forth fully herein.

### BACKGROUND OF THE INVENTION

Existing countertop ovens are limited in overall operating wattage due to the configuration and limitations of household circuit breakers. For example, a normal household 120-volt AC 15 amp circuit not dedicated to a range or oven has a wattage limit of around 1800 Watts. This wattage limit typically requires that countertop ovens plugged into the normal household circuit are limited to operating only a single cooking chamber and its heating elements at a time even when such ovens come equipped with multiple chambers. This situation can be frustrating to consumers because it conflicts with their normal expectation that both oven chambers would be able to operate simultaneously.

In light of these limitations there is an ongoing need for systems and methods that allow for simultaneous operation of multiple oven chambers in a countertop oven.

### SUMMARY

Embodiments described herein are directed to an oven that comprises a first chamber having a first plurality of heating elements and a first temperature sensor disposed therein. The oven also comprises a second chamber having a second plurality of heating elements and a second temperature sensor disposed therein. The oven additionally comprises a plurality of electrically controllable switching elements configured to selectively supply power to each of the first plurality of heating elements and each of the second plurality of heating elements. The oven further comprises a controller configured to direct the plurality of electrically controllable switching elements to selectively supply power to each of the first plurality of heating elements and each of the second plurality of heating elements based on a selected operating mode, and a respective current temperature value of the first temperature sensor and the second temperature sensor.

In some embodiments of the oven, the plurality of electrically controllable switching elements include a plurality of TRIACs. Additionally or alternatively, in some embodiments of the oven, the plurality of electrically controllable switching elements include a plurality of relays.

In some embodiments of the oven, when the selected operating mode includes a top chamber operating mode, the controller is configured to direct the plurality of electrically controllable switching elements to continually supply power to the first plurality of heating elements and refrain from supplying power to the second plurality of heating elements. Furthermore, in some embodiments of the oven, when the selected operating mode includes a bottom chamber operating mode, the controller is configured to direct the plurality of electrically controllable switching elements to continually supply power to the second plurality of heating elements and refrain from supplying power to the first plurality of heating elements. Further still, in some embodiments of the oven, when the selected operating mode includes a simultaneous operating mode the controller is configured to direct the plurality of electrically controllable switching elements to cycle through supplying power to different ones of the first plurality of heating elements and the second plurality of heating elements based on a respective operating stage of the first chamber and the second chamber and the respective current temperature value of the first temperature sensor and the second temperature sensor.

In some embodiments of the oven, when the selected operating mode includes a simultaneous operating mode and the controller determines that both the first chamber and the second chamber are in a pre-heat stage, the controller is configured to direct the plurality of electrically controllable switching elements to continually supply power to the second plurality of heating elements and to alternate between supplying power for a preconfigured amount of time to different ones of the first plurality of heating elements.

In some embodiments of the oven, when the selected operating mode includes a simultaneous operating mode and the controller determines that only the first chamber is in a pre-heat stage, the controller is configured to direct the plurality of electrically controllable switching elements to continually supply power to each of the first plurality of heating elements.

In some embodiments of the oven, when the selected operating mode includes a simultaneous operating mode, the first chamber is in a normal operating stage, and the controller determines that the respective current temperature value of the first temperature sensor is between a set temperature for the first chamber and a threshold amount below the set temperature for the first chamber, the controller is configured to direct the plurality of electrically controllable switching elements to continually supply power to each of the first plurality of heating elements.

In some embodiments of the oven, when the selected operating mode includes a simultaneous operating mode, the first chamber is in a normal operating stage, and the controller determines that the respective current temperature value of the first temperature sensor is above a set temperature for the first chamber and below a threshold amount over the set temperature for the first chamber, the controller is configured to direct the plurality of electrically controllable switching elements to alternate between supplying power for a preconfigured amount of time to different ones of the first plurality of heating elements.

In some embodiments of the oven, when the selected operating mode includes a simultaneous operating mode, the first chamber is in a normal operating stage, and the controller determines that the respective current temperature value of the first temperature sensor is equal to or above a threshold amount over a set temperature for the first chamber, the controller is configured to direct the plurality of electrically controllable switching elements to stop supplying power to each of the first plurality of heating elements.

In some embodiments of the oven, when the selected operating mode includes a simultaneous operating mode, the second chamber is in a normal operating stage, and the controller determines that the respective current temperature value of the second temperature sensor is equal to or above a set temperature for the second chamber, the controller is configured to direct the plurality of electrically controllable switching elements to stop supplying power to each of the second plurality of heating elements.

In some embodiments of the oven, when the selected operating mode includes a simultaneous operating mode, the second chamber is in a normal operating stage, and the controller determines that the respective current temperature value of the second temperature sensor is below a set temperature for the second chamber and the respective current temperature value of the first temperature sensor is greater than or equal to a set temperature for the first chamber, the controller is configured to direct the plurality of electrically controllable switching elements to continually supply power to each of the second plurality of heating elements.

In some embodiments of the oven, the first plurality of heating elements includes a first broil heating element and a first bake heating element and the second plurality of heating elements includes a second broil heating element and a second bake heating element. In these embodiments, the plurality of electrically controllable switching elements includes a first switch configured to selectively supply power to the first broil heating element, a second switch configured to selectively supply power to the first bake heating element, and a third switch configured to selectively supply power to both the second broil heating element and the second bake heating element.

Embodiments described herein are also directed to a method that comprises receiving a first set temperature for a first chamber of an oven and a second set temperature for a second chamber of the oven and receiving respective current temperature values from the first temperature sensor included within the first chamber and a second temperature sensor included within the second chamber. The method also comprises determining a respective operating stage of the first chamber and the second chamber based on the respective current temperature values from the first temperature sensor and the second temperature sensor. Further still, the method comprises controlling a plurality of switching elements to selectively supply power to a first plurality of heating elements of the first chamber and a second plurality of heating elements of the second chamber based on the respective operating stage of the first chamber and the second chamber and based on the respective current temperature values from the first temperature sensor and the second temperature sensor.

In some embodiments, the method comprises controlling the plurality of switching elements to continually supply power to the second plurality of heating elements and to alternate between supplying power for a preconfigured amount of time to different ones of the first plurality of heating elements when the respective operating stage for both the first chamber and the second chamber is a pre-heat stage.

In some embodiments, the method comprises controlling the plurality of switching elements to continually supply power to the second plurality of heating elements and to alternate between supplying power for a preconfigured amount of time to different ones of the first plurality of heating elements when the respective operating stage for both the first chamber is a normal stage and the respective current temperature value from the first temperature sensor is above the first set temperature and below a threshold amount over the first set temperature.

In some embodiments, the method comprises controlling the plurality of switching elements to continually supply power to each of the first plurality of heating elements when the respective operating stage for the first chamber is a pre-heat stage and the respective operating stage for the second chamber is a normal stage.

In some embodiments, the method comprises controlling the plurality of switching elements to continually supply power to each of the first plurality of heating elements when the respective operating stage for the first chamber is a normal operating stage and the respective current temperature value of the first temperature sensor is between the first set temperature and a threshold amount below the first set temperature.

In some embodiments, the method comprises controlling the plurality of switching elements to stop supplying power to each of the first plurality of heating elements when the respective operating stage for the first chamber is a normal operating stage and the respective current temperature value of the first temperature sensor is equal to or above a threshold amount over the first set temperature.

In some embodiments, the method comprises controlling the plurality of switching elements to stop supplying power to each of the second plurality of heating elements when the respective operating stage for the second chamber is a normal operating stage and the respective current temperature value of the second temperature sensor is equal to or above the second set temperature.

In some embodiments, the method comprises controlling the plurality of switching elements to continually supply power to each of the second plurality of heating elements when the respective operating stage for the second chamber is a normal operating stage and the respective current temperature value of the second temperature sensor is below the second set temperature and the respective current temperature value of the first temperature sensor is greater than or equal to the first set temperature.

### BRIEF DESCRIPTION OF THE DRAWINGS

For a better understanding of the present invention, reference may be made to the following accompanying drawings.

FIG. 1 is a perspective view of a double chamber oven constructed according to the teachings hereof.

FIG. 2 is block diagram of the double chamber oven of FIG. 1.

FIGS. 3 and 4 are a flow diagram of method according to the teachings hereof.

FIGS. 5A and 5B are flow diagram of a method according to the teachings hereof.

FIG. 6 is a flow diagram of a method according to the teachings hereof.

FIG. 7 is a flow diagram of a method according to the teachings hereof.

### DETAILED DESCRIPTION OF THE INVENTION

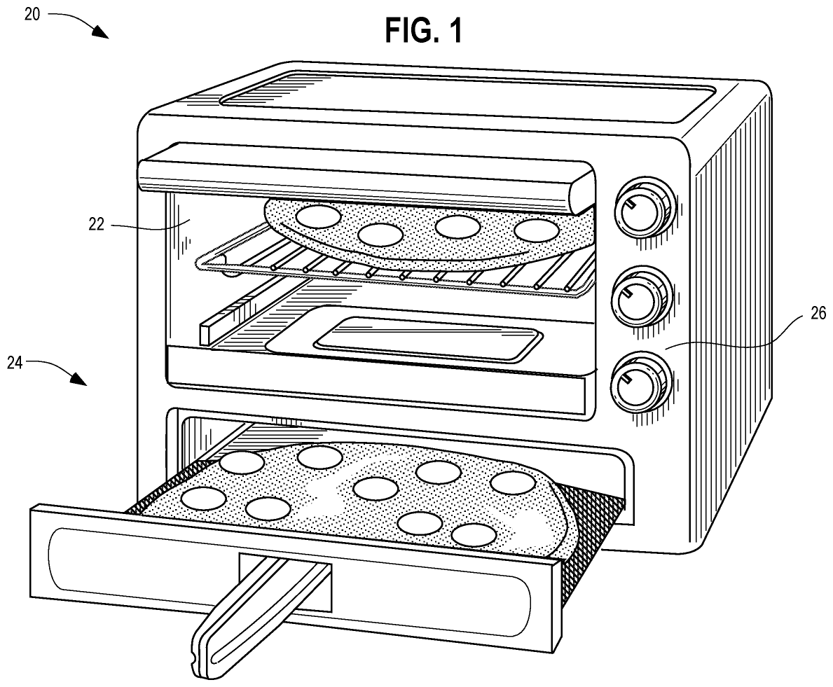

Turning to FIG. 1, an oven 20 according to disclosed embodiments is shown. As seen in FIG. 1, in some embodiments, the oven 20 can include a first chamber 22, a second chamber 24, and a control interface 26. In some embodiments, the first chamber 22 can be a top chamber or oven and the second chamber 24 can be a bottom chamber or oven. However, in other embodiments the first chamber 22 and the second chamber 24 can be positioned side by side. In some embodiments, the control interface 26 can include nobs or dials for setting various cooking modes, cooking times, and/or cooking temperatures for both the first chamber 22 and the second chamber 24. Additionally or alternatively, in some embodiments, the control interface 26 can include buttons and an information screen as known in the art. Furthermore, in some embodiments, some or all of the cooking modes, cooking times, and/or cooking temperatures can be set by a remote user device connected to the oven 20 via a wireless connection.

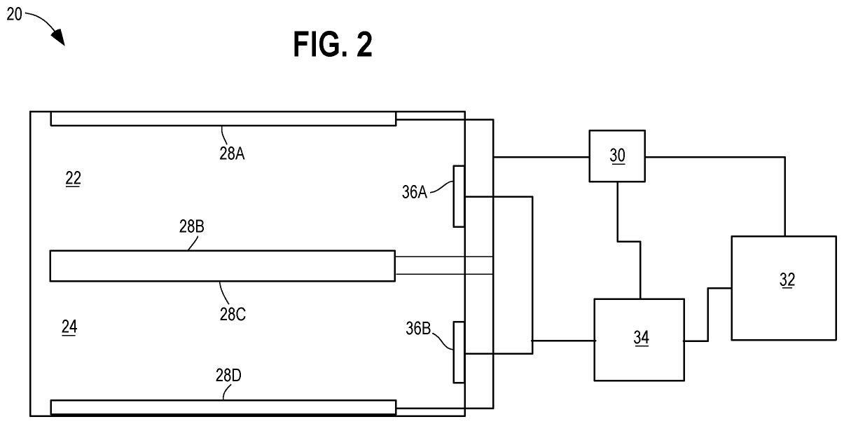

Turning to FIG. 2, a block diagram of the oven 20 according to disclosed embodiments is shown. As seen in FIG. 2, in some embodiments, the oven 20 can include a first plurality of heating elements 28A, 28B and a second plurality of heating elements 28C, 28D, a plurality of controllable switches 30 that can selectively power each of the first and second plurality of heating elements 28A, 28B, 28C, and 28D. For example, in some embodiments, plurality of controllable switches 30 can selectively couple each of the plurality of heating elements 28A, 28B, 28C, and 28D to a power source 32. Furthermore, the oven 20 can include a controller 34 that can control the plurality of controllable switches 30 and receive temperature information for the first chamber 22 and the second chamber 24 from temperature sensors 36A and 36B respectively. In some embodiments, the controller 34 can be connected to the control interface 26 shown in FIG. 1. In some embodiments, the power source 32 can include a standard 120 volt AC 15 amp circuit. However, other types of power sources known in the art are also contemplated.

In some embodiments, the controller 34 and/or the control interface 26 can include a transceiver device and a memory device, each of which can be in communication with control circuitry, one or more programmable processors, and executable control software as would be understood by one of ordinary skill in the art. In some embodiments, the control software can be stored on a transitory or non-transitory computer readable medium, including, but not limited to local computer memory, RAM, optical storage media, magnetic storage media, flash memory, and the like, and some or all of the control circuitry, the programmable processors, and the control software can execute and control at least some of the methods described herein.

In some embodiments, the heating element 28A can include a broil heating element positioned in a top section of the first chamber 22, the heating element 28B can include a bake heating element positioned in a bottom portion of the first chamber 22, the heating element 28C can include a broil heating element positioned in a top section of the second chamber 24, and the heating element 28D can include a bake heating element positioned in a bottom portion of the second chamber 24. Various configurations for each of the first and second plurality of heating elements 28A, 28B, 28C, and 28D are contemplated. For example, in some embodiments one or more of the first and second plurality of heating elements 28A, 28B, 28C, and 28D can be arranged in a snake configuration that winds around a large section of the interior of either the first chamber 22 and/or the second chamber 24. Additionally, in some embodiments, more than 4 heating elements can be included to enable the controller 34 to better control both the amount of heat being supplied to each chamber and the directionality of such heat. Moreover, various embodiments for the plurality of switches 30 are contemplated, including various relays, TRIACs and other electrical switching components known in the art.

In operation, the controller 34 can be configured to control the plurality of switches 30 to selectively power any of the first and second plurality of heating elements 28A, 28B, 28C, and 28D (e.g. by selectively coupling to the power source 32) to operate the oven 20 according to user settings entered via the control interface 26 and to ensure that the oven 20 does not exceed the typical wattage limit of home circuit breakers. For example, in traditional operating modes where only one of the first chamber 22 or the second chamber 24 is being used (e.g. a top operating mode or a bottom operating mode), the controller 34 will operate each of the first and second plurality of heating elements 28A, 28B, 28C, and 28D in the traditional manner where only the heating elements associated with the active chamber and the user selected heating mode are enabled to heat the active chamber. However, when the user selects an operation requiring that both the first chamber 22 and the second chamber 24 to operate simultaneously (e.g. a simultaneous operating mode) the controller 34 can be configured to employ a more complicated procedure to actively power different ones of the first and second plurality of heating elements 28A, 28B, 28C, and 28D to properly heat both the first chamber 22 and the second chamber 24 while ensuring the oven 20 does not exceed the maximum wattage limit for the conventional circuit breaker, which in some embodiments is approximately 1800 Watts.

For example, in some embodiments each of the first and second plurality of heating elements 28A, 28B, 28C, and 28D, can operate at around 500 Watts of heating power, so that if they were all activated and operated together the oven 20 would draw 2000 Watts of power, which is well over the rating of the standard household circuit breaker. Alternatively, in some embodiments, the first plurality of heating elements 28A, 28B can operate at 700 Watts of power each and the second plurality of heating elements 28C, 28D can operate at 400 Watts of power each for a total power draw of approximately 2200 Watts if activated together. In any embodiment, to prevent the oven 20 form tripping the breaker, the controller 34 can be configured to activate or deactivate each of the heating elements 28A, 28B, 28C, and 28D in different groupings using the plurality of switches 30. This selective activation and deactivation in combination with thermodynamic affects between each of the chambers 22 and 24 can allow simultaneous and independent operation of each oven chamber.

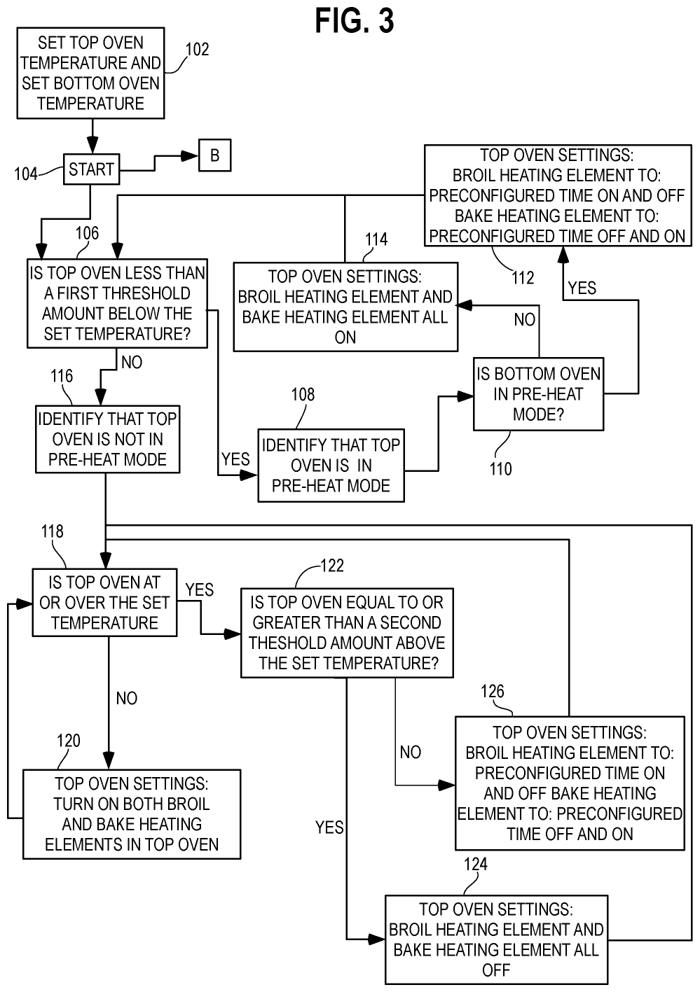

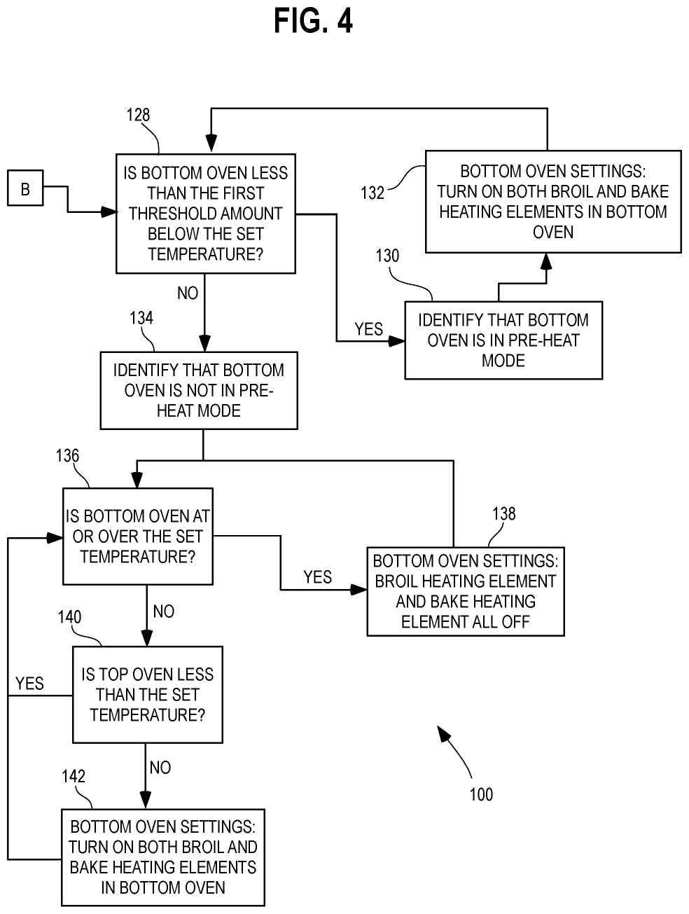

FIGS. 3 and 4 depict a method 100 executed by the controller 34 for simultaneous operation of the first chamber 22 and the second chamber 24 where the first chamber 22 is a top oven and the second chamber 24 is a bottom oven. As seen in FIG. 4, the method 100 can include setting a temperature for both the top oven 22 and the bottom oven 24, as in 102. For example, in some embodiments, the temperatures can be set using the control interface 26. After receiving set temperatures for both chambers, the method 100 can include initiating a process of simultaneously monitoring the temperatures in both the top and bottom ovens 22 and 24, and control of the first and second plurality of heating elements 28A, 28B, 28C, and 28D according to various rules, predetermined threshold temperature amounts, and prioritizations, as in 104.

For example, as seen in FIG. 4, in some embodiments the method 100 can include determining whether a current temperature of the top oven 22 is less than a first threshold amount below the set temperature for the top oven 22, as in 106. In some embodiments, the first threshold can be between approximately 10° F. and approximately 50° F. and the controller 34 can use the first temperature sensor 36A to measure the temperature inside the top oven 22. When the controller 34 determines that the current temperature in the top oven 22 is less than the first threshold amount below the set temperature for the top oven 22, the method 100 can include the controller identifying that the top oven 22 is still in a pre-heat mode, as in 108, and determining whether the bottom oven 24 is in pre-heat mode, as in 110. When both the top oven 22 and the bottom oven 24 are in the pre-heat mode, the method 100 can include the controller 34 controlling the plurality of switches 30 such that the broil heating element 28A and the bake heating element 28B of the top even 22 alternate between being on and off (e.g. connected to the power source 32 or disconnected form the power source 22) at a periodic interval such as every 5-60 seconds, as in 112. Alternating the broil heating element 28A and the bake heating element 28B while the bottom oven 24 is full ON pre-heating can enable the oven 20 to stay below the maximum wattage demand.

However, when only the top oven 114 is in the pre-heat mode, the method 100 can include the controller 34 controlling the plurality of switches 30 such that the broil heating element 28A and the bake heating element 28B of the top even 22 are both on (e.g. connected to the power source 32), as in 114. Then, after adjusting the settings of the top oven 22 in either steps 112 or 114, the method 100 can include the controller 34 continuing to determine whether the top oven 22 is less than the first threshold amount below the set temperature for the top oven 22, as in 106.

When the controller 34 determines in step 106 that the current temperature of the top oven 22 is not less then the first threshold amount below the set temperature for the top oven 22, the controller 34 can determine that the top oven 22 is no longer in the pre-heat mode, as in 116, and then check whether the top oven 22 is at or over the set temperature for the top oven 22, as in 118. When the controller 34 determines that the top oven 22 is not at or above the set temperature for the top oven 22, the method 100 can include the controller 34 controlling the plurality of switches 30 such that the broil heating element 28A and the bake heating element 28B of the top even 22 are both on (e.g. connected to the power source 32), as in 120. However, when the controller 34 determines that the top oven 22 is at or above the set temperature, the method 100 can include the controller 34 determining whether the current temperature of the top oven 22 is greater than a second threshold amount above the set temperature for the top oven 22, as in 122. In some embodiments, the second threshold amount can be an increment between approximately 10° F. and approximately 50° F. above the set temperature for the top oven 22.

Furthermore, when the controller 34 determines that the temperature in the top oven 22 is greater than the second threshold amount above the set temperature for the top oven 22, the method 100 can include the controller 34 controlling the plurality of switches 30 such that the broil heating element 28A and the bake heating element 28B of the top oven 22 are both off (e.g. not connected to the power source 32), as in 124. Turning off both the broil heating element 28A and the bake heating element 28B when the top oven 22 exceeds the second threshold amount helps prevent the oven 20 from exceeding the power limit.

However, when the controller 34 determines that the temperature in the top oven 22 is not greater than the second threshold amount above the set temperature for the top oven 22, the method 100 can include the controller 34 controlling the plurality of switches 30 such that the broil heating element 28A and the bake heating element 28B of the top even 22 alternate between being on and off (e.g. connected to the power source 32 or disconnected form the power source 32) at the periodic interval such as every 5-60 seconds, as in 126. Cycling the bake and broil elements to keep the top oven 22 just above the set temperature when the top oven 22 has reached set temperature will allow the bottom oven 24 to use full power to better recover any heat loss. Then, after adjusting the settings of the top oven 22 in either steps 120, 124, or 126, the method 100 can include the controller 34 continuing to determine whether the top oven 22 is at or over the set temperature, as in 118.

Turning now to FIG. 4, another section of the method 100 is shown. As seen in FIG. 4, the method 100 can include the controller 34 determining whether a current temperature of the bottom oven 24 is less than the first predetermined threshold amount below the set temperature for the bottom oven 24, as in 128. In some embodiments, the controller 34 can determine the current temperature of the bottom oven 24 using the temperature sensor 36B contained in the bottom oven 24. When the controller 34 determines that the temperature of the bottom oven 24 is less than the first predetermined threshold amount below the set temperature for the bottom oven 24, the method 100 can include the controller 34 identifying that the bottom oven 24 is in the pre-heat mode, as in 130; controlling the plurality of switches 30 such that the broil heating element 28C and the bake heating element 28D of the bottom oven 24 are both on (e.g. connected to the power source 32), as in 132; and continuing to determine whether the current temperature of the bottom oven 24 is less than the first predetermined threshold amount below the set temperature for the bottom oven 24, as in 128.

However, when the controller 34 determines that the temperature of the bottom oven 24 is not less than the first predetermined threshold amount below the set temperature for the bottom oven 24, the method 100 can include the controller 34 identifying that the bottom oven 24 is not in the pre-heat mode, as in 134, and determining whether the current temperature of the bottom oven 24 is at or over the set temperature for the bottom oven 24, as in 136.

When the controller 34 determines that the current temperature of the bottom oven 24 is at or over the set temperature, the method 100 can include the controller 34 controlling the plurality of switches 30 such that the broil heating element 28C and the bake heating element 28D of the bottom oven 24 are both off (e.g. not connected to the power source 32), as in 138. However, when the controller 34 determines that the current temperature of the bottom oven 24 is not at or over the set temperature, the method 100 can include the controller 34 determining whether the current temperature of the top oven 22 is less than the set temperature for the top oven 22, as in 140. When the controller 34 determines that the current temperature of the top oven 22 is not less than the set temperature for the top oven 22, the method 100 can include the controller 34 controlling the plurality of switches 30 such that the broil heating element 28C and the bake heating element 28D of the bottom oven 24 are both on (e.g. connected to the power source 32), as in 142. Then, after determining that the current temperature of the top oven 22 is less than the set temperature for the top oven 22 or performing any of steps 138 and 142, the method 100 can include continuing to determine whether the current temperature of the bottom oven 24 is at or over the set temperature for the bottom oven 24, as in 136.

In addition to the flow diagram of the method 100 shown in FIGS. 3 and 4 the various operating states for the oven 20 and the controller 34 according to some embodiments are summarized in Table 1 below. As seen in table 1, when in the pre-heat mode the second plurality of heating elements 28C and 28D of the lower oven 24 are energized fully ON and the first plurality of heating elements 28A and 28B are set to cycle back and forth at a determined time period to uniformly heat the upper oven 22. Since the second plurality of heating elements 28C and 28D are fully ON, the upper oven 22 can only use 1 set of heating elements at a time to stay below the wattage limit until the lower oven 24 reaches a determined temperature under the set temperature. In such embodiments, the plurality of switches 30 can include a first switch dedicated to the heating element 28A, a second switch dedicated to the heating element 28B, and a third switch dedicated to both of the second plurality of heating elements 28C and 28D.

When the lower oven 24 reaches the determined temperature under the set temperature, the second plurality of heating elements 28C and 28D will turn OFF, but the latent heat in the lower over 24 will cause the temperature of the lower oven 24 to continue rising up to the set temperature. Once the second plurality of heating elements 28C and 28D are OFF the first plurality of heating elements 28A and 28B are then able to be energized to fully ON until the upper oven 22 reaches a determined temperature below the set temperature for the upper oven 22. When the upper oven 22 reaches that temperature, both ovens will be pre-heated and in simultaneous cooking mode. Once each oven chamber has finished pre-heating and both ovens are ready to cook simultaneously, the upper oven 22 can be given priority for power demand over the lower oven 24. However, additional embodiments where the lower oven 24 is given priority are also contemplated.

For example, if the upper oven 22 is below the set temperature for the upper oven 22, both of the first plurality of heating elements 28A and 28B will be energized by the controller 34 and the plurality of switches 30 and the second plurality of heating elements 28C and 28D will be OFF. Once the upper oven 22 reaches the set temperature for the upper oven 22, the second plurality of heating elements 28C and 28D can be turned ON if needed. The first plurality of heating elements 28A and 28B can then be cycled back and forth at a determined time period to uniformly heat the upper oven 22 AND keep the upper oven 22 just above the set temperature for the upper oven 22. Keeping the upper oven 22 at or just above the set temperature allows the lower oven 24 more time to draw power and maintain its associated set temperature. The controller 34 can be configured to cycle the first plurality of heating elements 28A and 28B up to an upper limit temperature or time to avoid thermal run-away.

TABLE 1

| | Bottom | Bottom | | | |
|---|---|---|---|---|---|
| | Bake | Broil | Top Bake | Top Broil | Safety |
| Pre-Heat | Full | Full | Cycle ON - | Cycle OFF - | |
| | ON | ON | OFF for | ON for | |
| | | | preconfigured | preconfigured | |
| | | | time | time | |
| Bottom oven | Turn Off Lower Oven Pre-Heat Indicator | | | | |
| temp = first | | | | | |
| threshold | | | | | |
| before Set temp | | | | | |
| Bottom oven | OFF | OFF | ON | ON | |
| temp = first | | | | | |
| threshold | | | | | |
| before Set temp | | | | | |
| Top oven temp = | Turn Off Upper Oven Pre-Heat Indicator | | | | |
| first | | | | | |
| threshold | | | | | |
| before Set temp | | | | | |
| Top oven | OFF | OFF | Cycle ON - | Cycle OFF - | If Top Oven > |
| reaches Set | | | OFF for | ON for | second threshold |
| temp | | | preconfigured | preconfigured | over Set temp - |
| | | | time | time | Top Heating |
| | | | | | elements all OFF |
| Normal Oven | Top Oven has the priority for power usage | | | | |
| Operation | | | | | |
| If Top Oven < | OFF | OFF | ON | ON | |
| Set Temp | | | | | |
| If Bottom Oven < | ON | ON | Cycle ON - | Cycle OFF - | If Top Oven > |
| Set Temp | | | OFF for | ON for | second threshold |
| and Top Oven > | | | preconfigured | preconfigured | over Set temp - |
| Set Temp | | | time | time | Top Heating |
| | | | | | elements all OFF |
| If Bottom Oven > | OFF | OFF | ON | ON | |
| Set Temp | | | | | |
| and Top Oven < | | | | | |
| Set Temp | | | | | |
| If Bottom Oven > | OFF | OFF | Cycle ON - | Cycle OFF - | If Top Oven > |
| Set Temp | | | OFF for | ON for | second threshold |
| and Top Oven > | | | preconfigured | preconfigured | over Set temp - |
| Set Temp | | | time | time | Top Heating |
| | | | | | elements all OFF |

Additional or alternative embodiments for operating the first chamber 22 and the second chamber 24 simultaneously are also contemplated. For example, in some embodiments, the oven 20 can include a selective air transfer mechanism such as a fan and/or an actuatable vent between the first chamber 22 and the second chamber 23 that can be used by the controller 34 to control transfer of hot and/or cold air between the between the first chamber 22 and the second chamber 23. In some embodiments, the oven 20 can include multiple current and/or voltage sensors that can be used by the controller 34 together with the temperature sensors 36A and 36B to monitor the current temperature in the first chamber 22 and the second chamber 24 and to identify when to modify the operation of any of the first and second plurality of heating elements 28A, 28B, 28C, and 28D to keep the total power draw for the oven 20 below the standard circuit breaker limit or other preconfigured power draw limit.

Furthermore, in some embodiments, the oven 20 can include additional or alternative components that enable the controller 34 to limit the power drawn by the first and second plurality of heating elements 28A, 28B, 28C, and 28D from the power source 32 rather than simply disconnecting the first and second plurality of heating elements 28A, 28B, 28C, and 28D from the power source 32. For example, in some embodiments, the oven 20 can include TRIACs or similar electrical components such as AC phase controller controllable by the controller 34 to apply less than the maximum load to the first and second plurality of heating elements 28A, 28B, 28C, and 28D to ensure that the oven 20 does not exceed the breaker power limit. Furthermore, in some embodiments, the oven 20 can include electrical components such as diodes that can be switched into and out of the electrical path between the first and second plurality of heating elements 28A, 28B, 28C, and 28D and the power source 32 by the controller 34 using the plurality of switches 30 so as to limit the current drawn by any of the first and second plurality of heating elements 28A, 28B, 28C, and 28D.

In some embodiments, the oven 20 can also include an on device resettable breaker that will trip before the home breaker in the event that the controller 34 fails to keep the power draw below the breaker's limits. Having an on device breaker can improve the safety of the oven 20 and can increase convenience by enabling the user to reset the breaker at the oven 20 rather than having to reset the breaker in their home's circuit breaker panel.

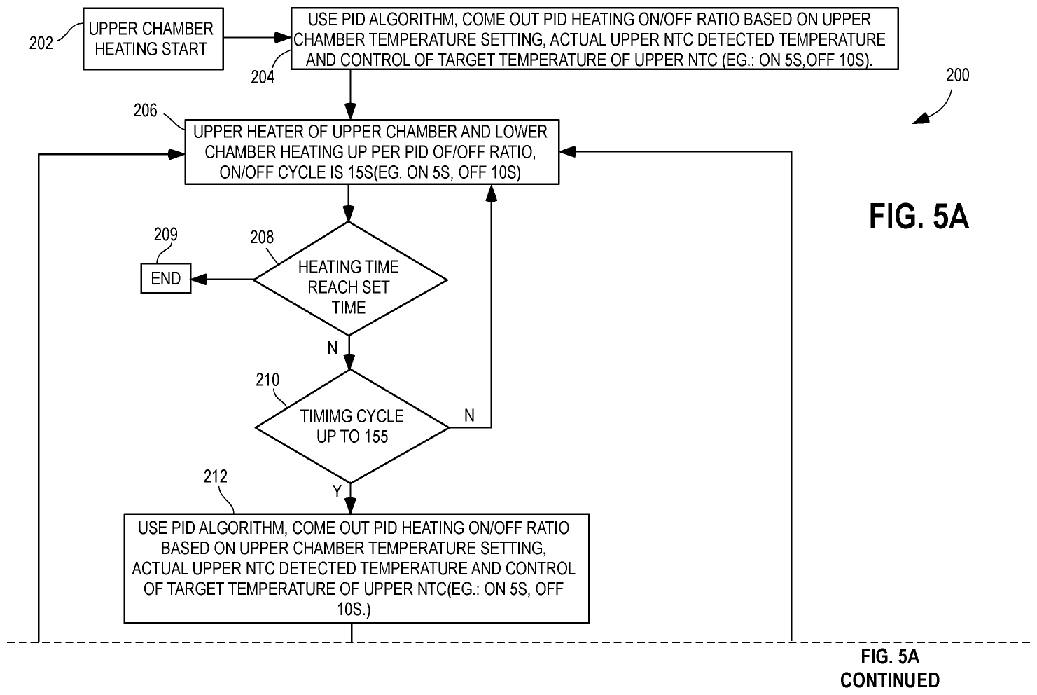

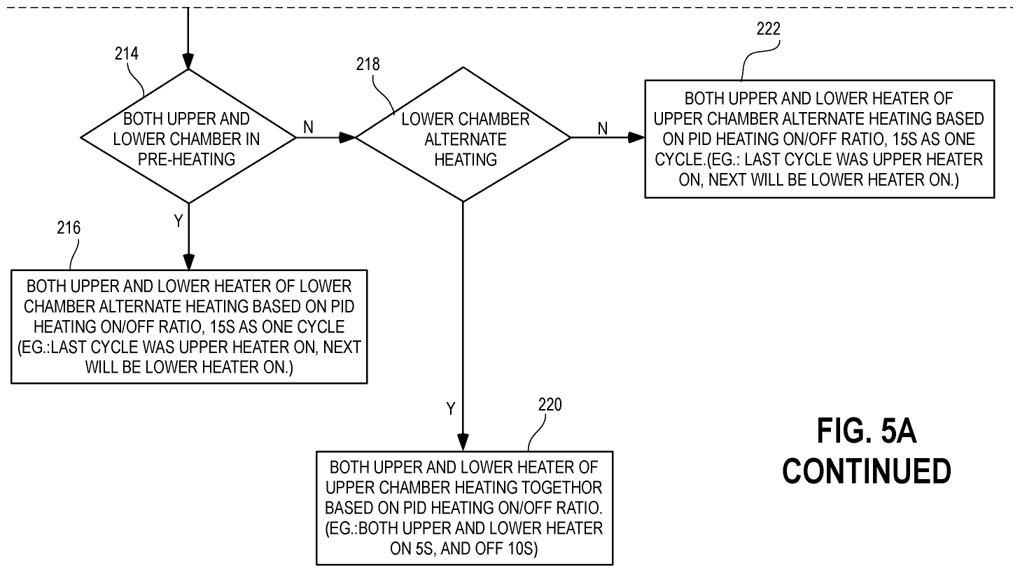

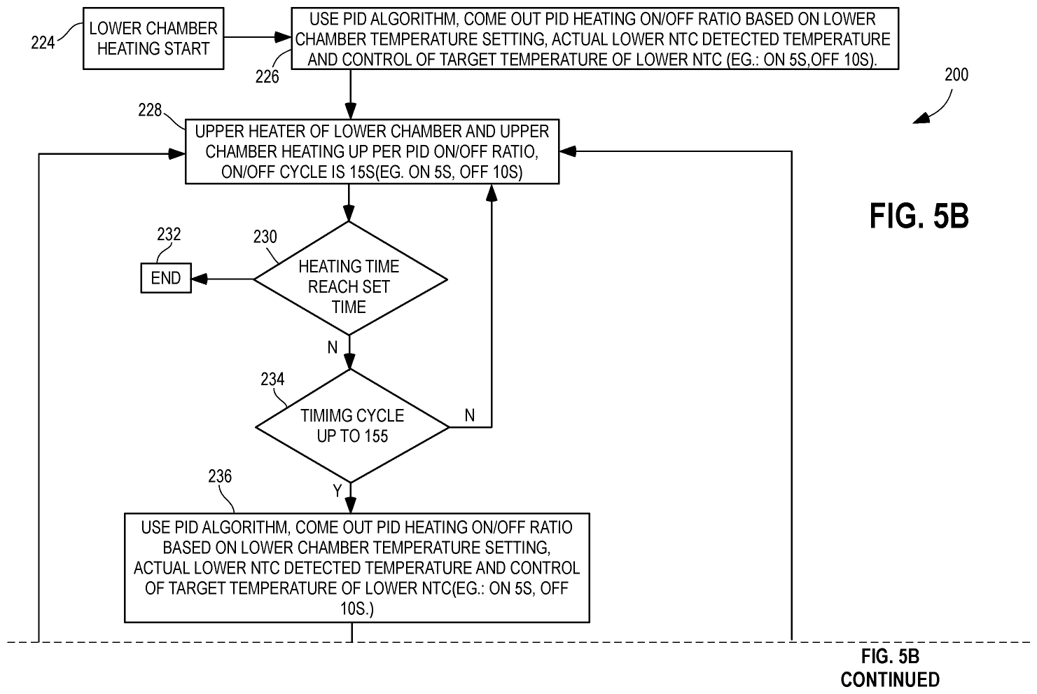

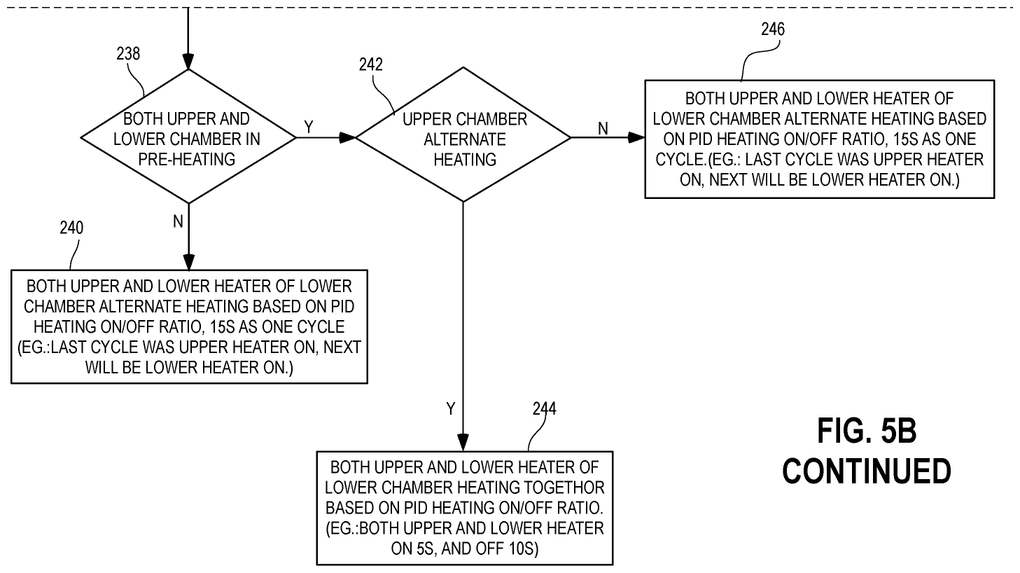

In some embodiments, the controller 34 can include a proportional-integral-derivative (PID) controller and the first and second temperature sensors 36A and 36B can include negative temperature coefficient (NTC) thermistors. FIGS. 5A and 5B show flow diagrams for a method 200 for simultaneously operating the upper chamber 22 and the lower chamber 24 using a PID for the controller 34 and NTC thermistors for the first and second temperature sensors 36A and 36B.

First, FIG. 5A shows a flow diagram for controlling the temperature of the upper chamber 22 as part of the method 200. As seen in FIG. 5A, the method 200 can include starting to heat the first plurality of heating elements 28A and 28B, as in 202, and engaging a PID algorithm to control heating in the upper chamber 22, as in 204. The PID algorithm can include the PID controller 34 (1) identifying a heating on/off ratio for the first plurality of heating elements 28A and 28B based on an upper chamber temperature setting and the actual detected temperature from the upper NTC thermistor 36A and (2) controlling the first plurality of heating elements 28A and 28B to achieve the target temperature of upper NTC thermistor 36A (e.g. employing the plurality of switches 30 to alternate the first plurality of heating elements 28A and 28B on for 5 s and off 10 s.).

Then, the method 200 can include initiating a PID heating cycle by controlling the heating element 28A of the upper chamber 22 while the lower chamber 24 is heating up according to the PID algorithm (e.g. an on/off cycle of 15 s, with 5 s on and 10 s off), as in 206. Then, the method 200 can include the PID controller 34 determining whether a heating set time has been reached, as in 208, and ending the method 200 when the set time has been reached, as in 209. However, when the set time has not been reached, the method 200 can include, the PID controller 34 determining whether the 15s timing cycle has elapsed, as in 210. When the timing cycle has not elapsed, the method 200 can include continuing to control the upper heating elements 28A of the upper chamber 22 while the lower chamber 24 is heating up according to the PID algorithm, as in 206.

However, once the timing cycle has elapsed, the method 200 can include using the PID algorithm, as in 212, and determining whether both the upper chamber 22 and the lower chamber 24 are in a pre-heating stage, as in 214. When both the both the upper chamber 22 and the lower chamber 24 are in the pre-heating stage, the method 200 can include the PID controller 34 alternating which of the first plurality of heating elements 28A and 28B is active for a next 15 s PID heating cycle, as in 216, and beginning the next PID heating cycle, as in 206. For example, where the heating element 28A was being controlled for the first iteration of the PID heating cycle, the heating element 28B will be activated for the second iteration of the PID heating cycle.

However, where both the both the upper chamber 22 and the lower chamber 24 are not in the pre-heating stage, the method 200 can include determining whether the lower chamber 24 is in an alternating heat mode, as in 218. When the lower chamber 24 is in the alternating heat mode, the method 200 can include the PID controller 34 activating both of the first plurality of heating elements 28A and 28B for a next 15 s PID heating cycle, as in 220, and beginning the next PID heating cycle, as in 206. However, when the lower chamber 24 is not in the alternating heat mode, the method 200 can include the PID controller 34 alternating which of the first plurality of heating elements 28A and 28B is active for a next 15 s PID heating cycle, as in 222, and beginning the next PID heating cycle, as in 206.

Second, FIG. 5B shows a flow diagram for controlling the temperature of the lower chamber 24 as part of the method 200. As seen in FIG. 5B, the method 200 can include starting to heat the second plurality of heating elements 28C and 28D, as in 224, and engaging the PID algorithm to control heating in the lower chamber 24, as in 226. As such, the PID algorithm can also include the PID controller 34 (1) identifying a heating on/off ratio for the second plurality of heating elements 28C and 28D based on a lower chamber temperature setting and the actual detected temperature from the lower NTC thermistor 36B and (2) controlling the second plurality of heating elements 28C and 28D to achieve the target temperature of lower NTC thermistor 36B (e.g. employing the plurality of switches 30 to alternate the first plurality of heating elements 28A and 28B on for 5 s and off 10 s).

Then, the method 200 can include initiating the PID heating cycle for the lower chamber 24 by controlling the second plurality of heating elements 28C and 28 D, as in 228. Then, the method 200 can include the PID controller 34 determining whether a heating set time has been reached, as in 230, and ending the method 200 when the set time has been reached, as in 232. However, when the set time has not been reached, the method 200 can include, the PID controller 34 determining whether the 15s timing cycle has elapsed, as in 234. When the timing cycle has not elapsed, the method 200 can include continuing to control the second plurality of heating elements 28C and 28 D according to the PID algorithm, as in 228.

However, once the timing cycle has elapsed, the method 200 can include using the PID algorithm, as in 236, and determining whether both the upper chamber 22 and the lower chamber 24 are in a pre-heating stage, as in 238. When both the both the upper chamber 22 and the lower chamber 24 are not in the pre-heating stage, the method 200 can include the PID controller 34 alternating which of the second plurality of heating elements 28C and 28D is active for a next 15 s PID heating cycle, as in 240, and beginning the next PID heating cycle, as in 228. For example, where the heating element 28C was being controlled for the first iteration of the PID heating cycle, the heating element 28D will be activated for the second iteration of the PID heating cycle.

However, where both the both the upper chamber 22 and the lower chamber 24 are in the pre-heating stage, the method 200 can include determining whether the upper chamber 22 is in an alternating heat mode, as in 242. When the upper chamber 22 is in the alternating heat mode, the method 200 can include the PID controller 34 activating both of the second plurality of heating elements 28C and 28D for a next 15 s PID heating cycle, as in 244, and beginning the next PID heating cycle, as in 228. However, when the upper chamber 22 is not in the alternating heat mode, the method 200 can include the PID controller 34 alternating which of the first plurality of heating elements 28C and 28D is active for a next 15 s PID heating cycle, as in 246, and beginning the next PID heating cycle, as in 228.

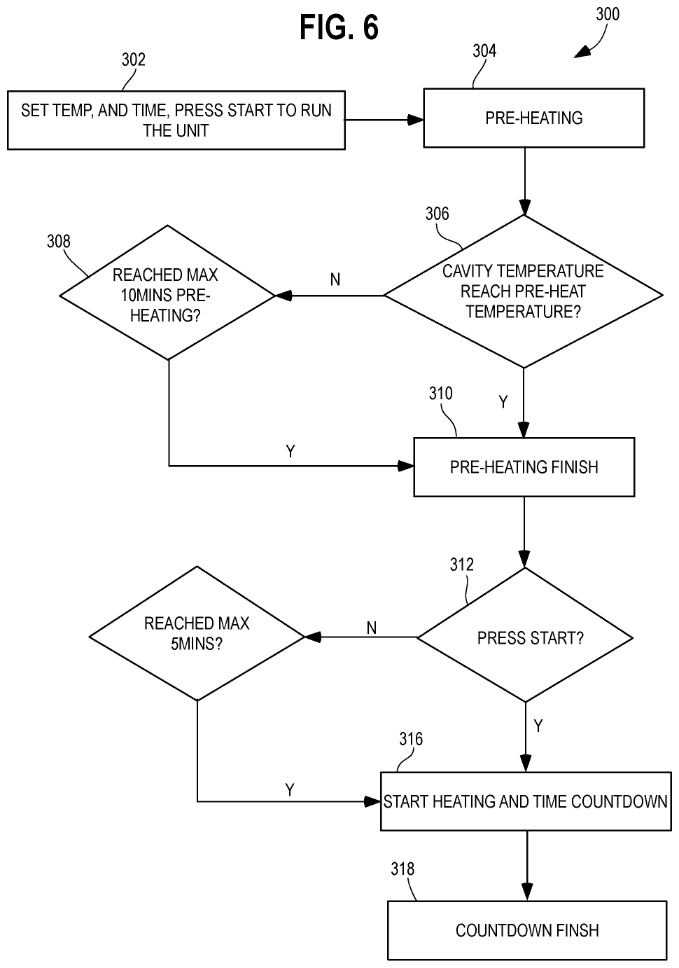

FIG. 6 is a flow diagram of a method 300 for operating the oven 20 in a top chamber operating mode. As seen in FIG. 6, the method 300 can include setting a temperature and time to run the top chamber 22 and receiving user input on a start button, as in 302. Then, the method 300 can include preheating the top chamber 22 using the first plurality of heating elements 28A and 28B, as in 304. Next, the method 300 can include determining whether the temperature in the top chamber 22 has reached a pre-heat temperature, as in 306. When the temperature in the top chamber 22 has not reached the pre-heat temperature, the method 300 can include determining whether a max pre-heating time such as 10 minutes has been reached, as in 308. When the max pre-heating time has not been reached, the method 300 can include continue to determine whether the temperature in the top chamber 22 has reached a pre-heat temperature, as in 306.

However, when the temperature in the top chamber 22 has reached the pre-heat temperature or the max pre-heating time has been reached, the method 300 can include, finishing the pre-heating stage and determining whether additional user input activating the start button has been received, as in 310 and 312. When the user input activating the start button has not been received, the method 300 can include determining whether a max waiting time such as 5 minutes has been reached, as in 314. When the max waiting time has not been reached, the method 300 can include, continuing to determine whether the additional user input activating the start button has been received, as in 312. However, when the additional user input has been received or the max waiting time has been reached, the method 300 can include starting a normal heating operation of the top chamber 22 and activating a countdown timer, as in 316. Then when the countdown timer has expired, the method 300 can include finishing the method 300, as in 318.

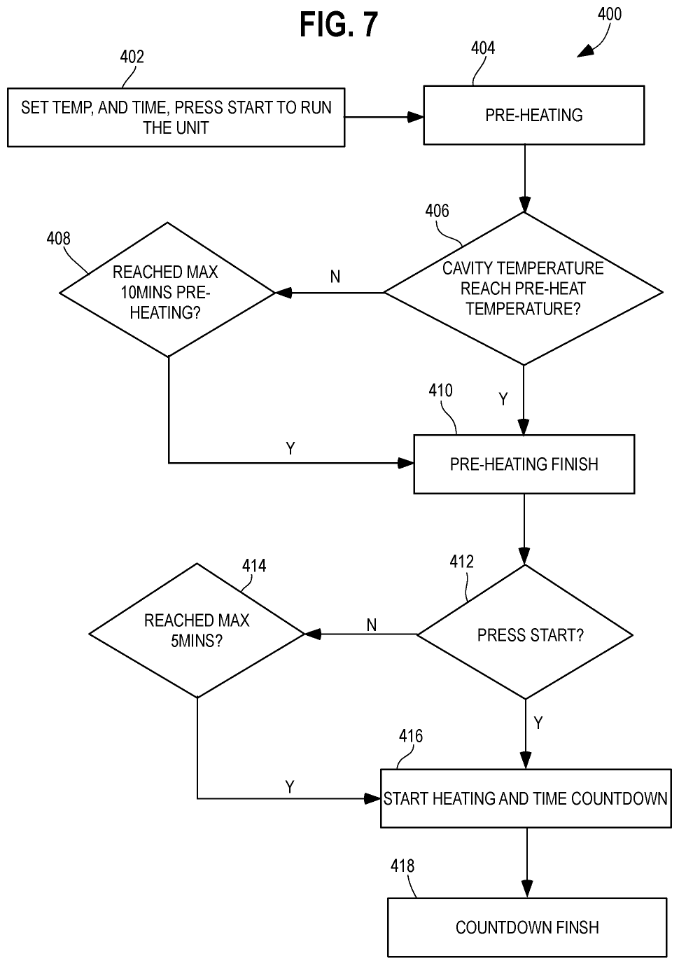

FIG. 7 is a flow diagram of a method 400 for operating the oven 20 in a bottom chamber operating mode. As seen in FIG. 7, the method 400 can include setting a temperature and time to run the bottom chamber 24 and receiving user input on a start button, as in 402. Then, the method 400 can include preheating the bottom chamber 24 using the second plurality of heating elements 28C and 28D, as in 404. Next, the method 400 can include determining whether the temperature in the bottom chamber 24 has reached a pre-heat temperature, as in 406. When the temperature in the bottom chamber 24 has not reached the pre-heat temperature, the method 400 can include determining whether a max pre-heating time such as 10 minutes has been reached, as in 408. When the max pre-heating time has not been reached, the method 400 can include continue to determine whether the temperature in the bottom chamber 24 has reached a pre-heat temperature, as in 406.

However, when the temperature in the bottom chamber 24 has reached the pre-heat temperature or the max pre-heating time has been reached, the method 400 can include, finishing the pre-heating stage and determining whether additional user input activating the start button has been received, as in 410 and 412. When the user input activating the start button has not been received, the method 400 can include determining whether a max waiting time such as 5 minutes has been reached, as in 414. When the max waiting time has not been reached, the method 400 can include, continuing to determine whether the additional user input activating the start button has been received, as in 412. However, when the additional user input has been received or the max waiting time has been reached, the method 400 can include starting a normal heating operation of the bottom chamber 24 and activating a countdown timer, as in 416. Then when the countdown timer has expired, the method 400 can include finishing the method 400, as in 418.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

What is claimed is:

1. An oven comprising:
a first chamber having a first plurality of heating elements and a first temperature sensor disposed therein;
a second chamber having a second plurality of heating elements and a second temperature sensor disposed therein;
a plurality of electrically controllable switching elements configured to selectively supply power to each of the first plurality of heating elements and each of the second plurality of heating elements; and
a controller configured to direct the plurality of electrically controllable switching elements to selectively supply power to each of the first plurality of heating elements and each of the second plurality of heating elements based on a selected operating mode, and a respective current temperature value of the first temperature sensor and the second temperature sensor.

2. The oven of claim 1 wherein the plurality of electrically controllable switching elements include a plurality of TRIACs.

3. The oven of claim 1 wherein the plurality of electrically controllable switching elements include a plurality of relays.

4. The oven of claim 1 wherein when the selected operating mode includes a top chamber operating mode, the controller is configured to direct the plurality of electrically controllable switching elements to continually supply power to the first plurality of heating elements and refrain from supplying power to the second plurality of heating elements, wherein when the selected operating mode includes a bottom chamber operating mode, the controller is configured to direct the plurality of electrically controllable switching elements to continually supply power to the second plurality of heating elements and refrain from supplying power to the first plurality of heating elements, and wherein when the selected operating mode includes a simultaneous operating mode the controller is configured to direct the plurality of electrically controllable switching elements to cycle through supplying power to different ones of the first plurality of heating elements and the second plurality of heating elements based on a respective operating stage of the first chamber and the second chamber and the respective current temperature value of the first temperature sensor and the second temperature sensor.

5. The oven on claim 1 wherein, when the selected operating mode includes a simultaneous operating mode and the controller determines that both the first chamber and the second chamber are in a pre-heat stage, the controller is configured to direct the plurality of electrically controllable switching elements to continually supply power to the second plurality of heating elements and to alternate between supplying power for a preconfigured amount of time to different ones of the first plurality of heating elements.

6. The oven on claim 1 wherein, when the selected operating mode includes a simultaneous operating mode and the controller determines that only the first chamber is in a pre-heat stage, the controller is configured to direct the plurality of electrically controllable switching elements to continually supply power to each of the first plurality of heating elements.

7. The oven on claim 1 wherein, when the selected operating mode includes a simultaneous operating mode, the first chamber is in a normal operating stage, and the controller determines that the respective current temperature value of the first temperature sensor is between a set temperature for the first chamber and a threshold amount below the set temperature for the first chamber, the controller is configured to direct the plurality of electrically controllable switching elements to continually supply power to each of the first plurality of heating elements.

8. The oven on claim 1 wherein, when the selected operating mode includes a simultaneous operating mode, the first chamber is in a normal operating stage, and the controller determines that the respective current temperature value of the first temperature sensor is above a set temperature for the first chamber and below a threshold amount over the set temperature for the first chamber, the controller is configured to direct the plurality of electrically controllable switching elements to alternate between supplying power for a preconfigured amount of time to different ones of the first plurality of heating elements.

9. The oven on claim 1 wherein, when the selected operating mode includes a simultaneous operating mode, the first chamber is in a normal operating stage, and the controller determines that the respective current temperature value of the first temperature sensor is equal to or above a threshold amount over a set temperature for the first chamber, the controller is configured to direct the plurality of electrically controllable switching elements to stop supplying power to each of the first plurality of heating elements.

10. The oven of claim 1 wherein, when the selected operating mode includes a simultaneous operating mode, the second chamber is in a normal operating stage, and the controller determines that the respective current temperature value of the second temperature sensor is equal to or above a set temperature for the second chamber, the controller is configured to direct the plurality of electrically controllable switching elements to stop supplying power to each of the second plurality of heating elements.

11. The oven of claim 1 wherein, when the selected operating mode includes a simultaneous operating mode, the second chamber is in a normal operating stage, and the controller determines that the respective current temperature value of the second temperature sensor is below a set temperature for the second chamber and the respective current temperature value of the first temperature sensor is greater than or equal to a set temperature for the first chamber, the controller is configured to direct the plurality of electrically controllable switching elements to continually supply power to each of the second plurality of heating elements.

12. The oven of claim 1 wherein the first plurality of heating elements includes a first broil heating element and a first bake heating element, wherein the second plurality of heating elements includes a second broil heating element and a second bake heating element, wherein the plurality of electrically controllable switching elements includes a first switch configured to selectively supply power to the first broil heating element, a second switch configured to selectively supply power to the first bake heating element, and a third switch configured to selectively supply power to both the second broil heating element and the second bake heating element.

13. A method comprising:
receiving a first set temperature for a first chamber of an oven and a second set temperature for a second chamber of the oven;
receiving respective current temperature values from a first temperature sensor included within the first chamber and a second temperature sensor included within the second chamber;
determining a respective operating stage of the first chamber and the second chamber based on the respective current temperature values from the first temperature sensor and the second temperature sensor; and
controlling a plurality of switching elements to selectively supply power to a first plurality of heating elements of the first chamber and a second plurality of heating elements of the second chamber based on the respective operating stage of the first chamber and the second chamber and based on the respective current temperature values from the first temperature sensor and the second temperature sensor.

14. The method of claim 13 further comprising:
controlling the plurality of switching elements to continually supply power to the second plurality of heating elements and to alternate between supplying power for a preconfigured amount of time to different ones of the first plurality of heating elements when the respective operating stage for both the first chamber and the second chamber is a pre-heat stage.

15. The method of claim 13 further comprising:
controlling the plurality of switching elements to continually supply power to the second plurality of heating elements and to alternate between supplying power for a preconfigured amount of time to different ones of the first plurality of heating elements when the respective operating stage for both the first chamber is a normal stage and the respective current temperature value from the first temperature sensor is above the first set temperature and below a threshold amount over the first set temperature.

16. The method of claim 13 further comprising:
controlling the plurality of switching elements to continually supply power to each of the first plurality of heating elements when the respective operating stage for the first chamber is a pre-heat stage and the respective operating stage for the second chamber is a normal stage.

17. The method of claim 13 further comprising:
controlling the plurality of switching elements to continually supply power to each of the first plurality of heating elements when the respective operating stage for the first chamber is a normal operating stage and the respective current temperature value of the first temperature sensor is between the first set temperature and a threshold amount below the first set temperature.

18. The method of claim 13 further comprising:
controlling the plurality of switching elements to stop supplying power to each of the first plurality of heating elements when the respective operating stage for the first chamber is a normal operating stage and the respective current temperature value of the first temperature sensor is equal to or above a threshold amount over the first set temperature.

19. The method of claim 13 further comprising:
controlling the plurality of switching elements to stop supplying power to each of the second plurality of heating elements when the respective operating stage for the second chamber is a normal operating stage and the respective current temperature value of the second temperature sensor is equal to or above the second set temperature.

20. The method of claim 13 further comprising:
controlling the plurality of switching elements to continually supply power to each of the second plurality of heating elements when the respective operating stage for the second chamber is a normal operating stage and the respective current temperature value of the second temperature sensor is below the second set temperature and the respective current temperature value of the first temperature sensor is greater than or equal to the first set temperature.
